(19) United States
(12) Patent Application Publication
(10) Pub. No.: US 2006/0280067 A1
(43) Pub. Date: Dec. 14, 2006

(54) Audio data search control device

(76) Inventors: Hiroshi Satoh, Osaka (JP); Naoki Hori, Osaka-shi (JP)

Correspondence Address: MCDERMOTT WILL & EMERY LLP, 600 13TH STREET, N.W., WASHINGTON, DC, 20005-3096, US

(21) Appl. No.: 10/562,795

(22) PCT Filed: Jul. 1, 2004
(86) PCT No.: PCT/JP04/09674

§ 371 Date: May 24, 2006

(30) Foreign Application Priority Data
Jul. 1, 2003 (JP) 2003-189432

(51) Int. Cl. G11B 5/09

(52) U.S. Cl. 369/47.1

(57) ABSTRACT

In a multi-session disk, a microcomputer of an audio data search control apparatus judges whether or not a search operation for a last audio data file in an optional session during the search operation in the session (Step S11), forcibly moves an optical pickup 11 during a required forcible-movement time length T along a radial direction of the multi-session disk when it is judged that the search operation is completed (Steps S12 and S13), and restarts the search operation in a next session of a different format after the forcible movement is completed (Steps S14-S16).

### FIELD OF THE INVENTION

The present invention relates to an audio data search control apparatus for controlling the search of data recorded on a multi-session disk.

### BACKGROUND OF THE INVENTION

Hereinafter, a conventional technology is described referring to the accompanying drawings.

FIG. 13 is a block diagram of playback equipment for a disk capable of handling compressed audio. Referring to reference numerals in FIG. 13, 10 denotes an optical disk, 11 denotes an optical pickup, 12 denotes an optical pickup driver, 13 denotes a servo circuit (comprising LSI), 14 denotes a microcomputer, 15 denotes a compressed audio decoder, and 16 denotes a memory.

A laser beam emitted from a laser equipped with the optical pickup 11 is reflected on the optical disk 10 and enters the optical pickup 11 through a lens not shown. The optical pickup 11 converts the incident laser beam into an electrical signal and amplifies it, and thereafter generates a focus error signal and a tracking error signal and inputs these signals to the servo circuit 13 via the optical pickup driver 12. The servo circuit 13 controls a focus of the optical pickup 11 via the optical pickup driver 12 based on the focus error signal, controls a focus motor via the optical pickup driver 12 to carry out a focus control of the lens, and a tracking of the optical pickup 11 is controlled via the optical pickup driver 12 based on the tracking error signal. Finally, the servo circuit 13 controls a rotation frequency of a spindle motor which rotates the optical disk 10 based on a synchronous signal.

The servo circuit 13 demodulates the signal read from the optical disk 10 and stores the demodulated signal in the memory 16. The data stored in the memory 16 is made digital/analog (DA) conversion, and an analog voice is outputted from the memory 16. With respect to the compressed audio, only a musical information is stored in the memory 16. The part of the data stored in the memory 16 is decoded by the compressed audio decoder 15 and DA conversion is made, and an analog voice is outputted from the memory 16.

A conventional search operation for the audio data is described referring to FIG. 14.

In Step S71, the microcomputer 14 judges whether or not the optical pickup 11 has reached the end of a last compressed data file in a session currently being reproduced, and advances to Step S72 when the optical pickup 11 has reached the end. The file mentioned here is merely a general term that indicates a data having a certain meaning.

In the Step S72, the microcomputer 14 judges whether or not the search operation is completed, and advances to Step S73 when it is judged that the search operation is not completed yet, and stands by at the end of a last piece of music in the session. When it is judged that the search operation is completed, the microcomputer 14 advances to Step S74 to terminate the search operation.

In recent years, a multi-session disk in which data of various disk formats is recorded on a single optical disk has been commercialized. In the multi-session disk, there is a gap in the data between the respective sessions, wherein the session comprises a lead-in region that indicates a recording starting position, a data region for the data itself, and a lead-out region that indicates a recording ending position. The multi-session disk is the one in which a multiple number of such sessions are recorded, wherein the lead-out region of the session is followed by the lead-in region of the next session.

FIG. 15 shows an example of data recorded on the multi-session disk, wherein a multi-session disk is shown as an example in which the data by two formats according to MP3 (abbreviation for MPEG Audio Layer-3) and CD-DA (abbreviation for Compact Disc Digital Audio) are intermixed. The MPEG (Moving Picture Experts Group) is the global standard for compressing a moving image, and MP3 serves to encode an audio data of a high quality such as music. As shown in FIG. 15, the lead-out region from the MP3 data (audio data of MP3) and the lead-in region to the CD-DA data (audio data of CD-DA) are provided in the multi-session disk. The combination of a lead-out region RO and a lead-in region RI constitutes an inter-session gap G.

In case that the conventional search method for the audio data shown in FIG. 14 is applied to the multi-session disk, the stand-by occurs at the end of the final piece of music in the session, which makes it impossible to perform the search operation to the audio data between the session.

Further, if the stand-by is cancelled so that the search operation is continuously executed in the same direction, a noise is superimposed on the voice reproduced during the transfer on the inter-session gap G, which results in the generation of an abnormal sound.

### SUMMARY OF THE INVENTION

An audio data search control apparatus according to the present invention comprises a pickup capable of moving on a multi-session disk in a radial direction thereof and a microcomputer for controlling the movement of the pickup, wherein the microcomputer executes the following three steps comprising a first step for judging whether or not a search processing for a last audio data file in an optional session is completed during the search in the session, a second step for forcing movement of the pickup during a required length of time for moving by force along the radial direction of the disk when it is judged that the search operation is completed, and a third step for restarting the search action in a next session according to a different format after the forcible movement is completed.

According to the present invention, the pickup is moved by force along the radial direction of the disk for the required length of time after the search operation for the last audio data file in the session is completed. Therefore, the pickup can jump over an inter-session gap without fail. The required time length of movement by force can be determined based on a length of the one required for jumping over number of tracks corresponding to the inter-session gap. Because the search processing for the audio data file is restarted in the next session after the pickup jumps over the inter-session gap and then moves surely to the next session, a detection of the head of audio data file in the next session can be accurately carried out. The data output is interrupted during the movement by force of the pickup for jumping over the inter-session gap in order that the data in the inter-session gap is not reproduced as output,_and the jump over the inter-session gap is realized without generating any abnormal sound.

As a preferred embodiment of the present invention, an optimum length of time for the forcible movement corresponding to a positional information of the pickup on the disk is obtained and the pickup is forced to move along the radial direction of the disk during the optimum forcible-movement time length in the second step when it is judged in the first step that the search operation is completed.

As a more preferred embodiment of the present invention, the microcomputer executes the following steps comprising a first step for judging whether or not a search operation for a last audio data file in an optional session is finished during the search control in the session, a second step for jumping the pickup over a required number of jumping tracks along the radial direction of the disk, and a third step for restarting the search action in a next session according to a different format when the track jump is completed in the second step.

As another preferred embodiment of the present invention, an optimum number of jumping tracks corresponding to a positional information of the pickup on the disk is obtained and the pickup is jumped over the just that number of jumping tracks along the radial direction of the disk in the second step when it is judged in the first step that the search operation is completed.

In the present invention, the radial direction disk where the pickup is forcibly moved and jumped over the tracks may either an outward direction or an inward direction to a radius. The present invention can be applied to any apparatus for an optical disk, a magneto-optical disk and a magnetic disk. The pickup includes an optical pickup, a magnetic pickup and the like. The apparatus may be a playback apparatus or a recording/playback apparatus.

### BRIEF DESCRIPTION OF THE DRAWINGS

FIG. 1 is a flow chart of an audio data search control apparatus according to an embodiment 1 of the present invention.

FIG. 2 is a flow chart of an audio data search control apparatus according to an embodiment 2 of the present invention.

FIG. 3 is a flow chart of an audio data search control apparatus according to an embodiment 3 of the present invention.

FIG. 4 is a flow chart of an audio data search control apparatus according to an embodiment 4 of the present invention.

FIG. 5 is a flow chart of an audio data search control apparatus according to an embodiment 5 of the present invention.

FIG. 6 is a flow chart of the audio data search control apparatus according to the embodiment 5 (continued from FIG. 5).

FIG. 7 is a flow chart of an audio data search control apparatus according to an embodiment 6 of the present invention.

FIG. 8 is a flow chart of the audio data search control apparatus according to the embodiment 6 (continued from FIG. 7).

FIG. 9 is a flow chart of an audio data search control apparatus according to an embodiment 7 of the present invention.

FIG. 10 is a flow chart of the audio data search control apparatus according to the embodiment 7 (continued from FIG. 9).

FIG. 11 is a flow chart of an audio data search control apparatus according to an embodiment 8 of the present invention.

FIG. 12 is a flow chart of the audio data search control apparatus according to the embodiment 8 (continued from FIG. 11).

FIG. 13 is a block diagram illustrating a constitution of a disk playback apparatus according to a conventional technology and the preferred embodiments of the present invention.

FIG. 14 is a flow chart of an audio data search control apparatus according to the conventional technology.

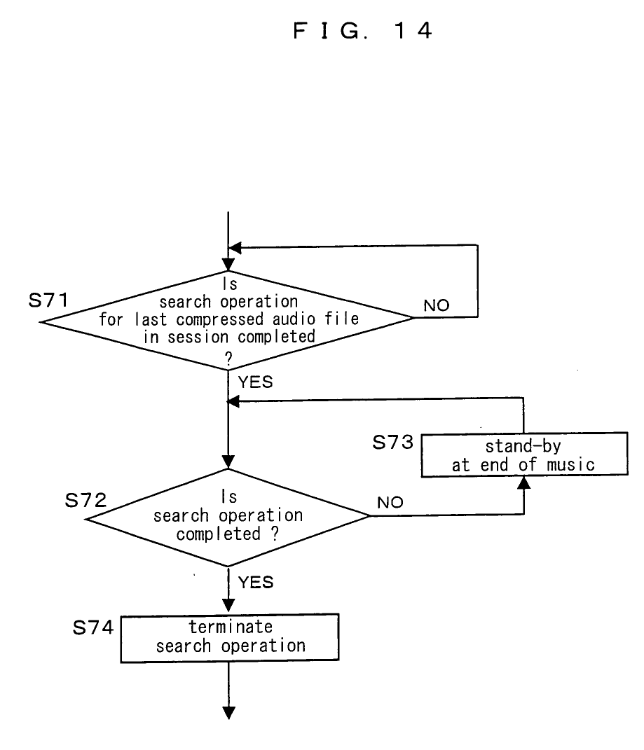

FIG. 15 shows an example of data recorded on a multi-session disk.

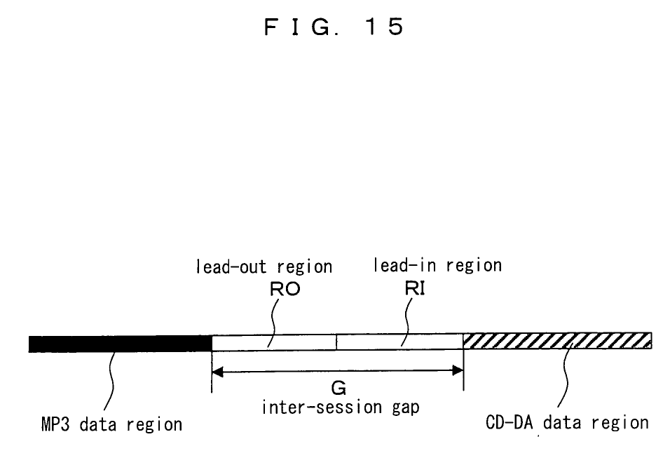

### DETAILED DESCRIPTION OF PREFERRED EMBODIMENTS

Hereinafter, preferred embodiments of the present invention are illustrated referring to the accompanying drawings.

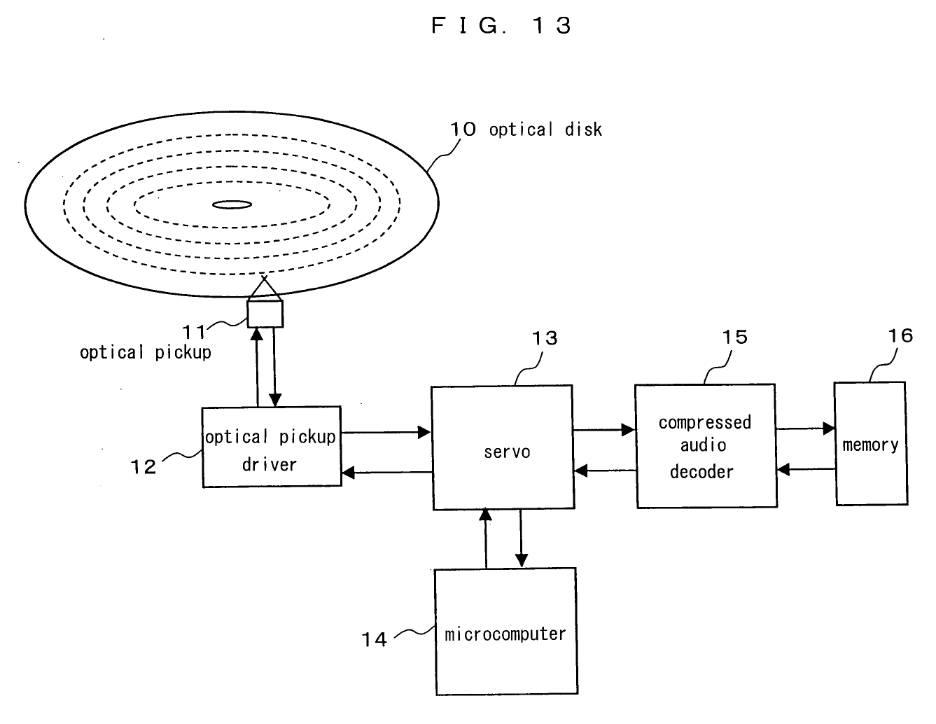

A disk playback equipment according to the preferred embodiments of the present invention has a block constitution shown in FIG. 13 in the same manner as in the conventional technology. Referring to reference numerals in FIG. 13, 10 denotes an optical disk (multi-session disk), 11 denotes an optical pickup, 12 denotes an optical pickup driver, 13 denotes a servo circuit, 14 denotes a microcomputer, 15 denotes a compressed audio decoder, and 16 denotes a memory.

The audio data search control apparatus according to the preferred embodiments emits a laser beam to the multi-session disk 10 and invites therein the laser beam reflected on the multi-session disk 10, wherein it comprises the optical pickup 11 capable of moving on the multi-session disk 10 to a radial direction and the microcomputer 14 controlling the movement of the optical pickup 11 through driver 12 and servo circuit 13.

### Embodiment 1

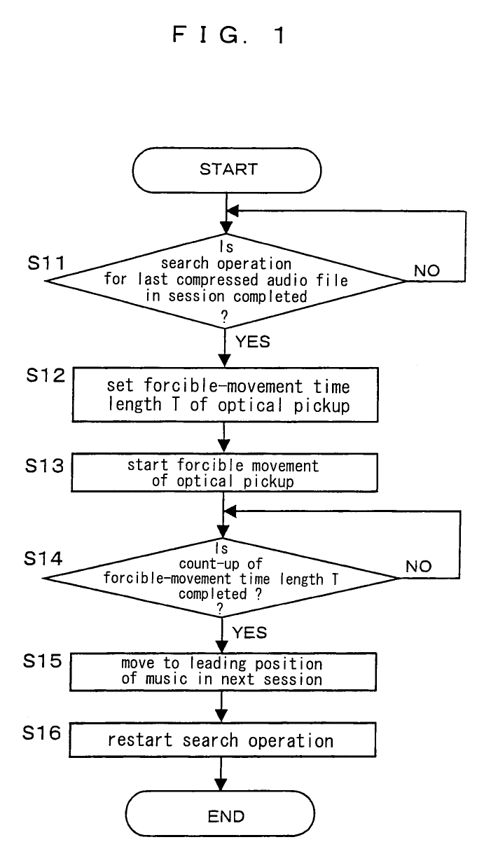

Below is described an audio data search control apparatus according to an embodiment 1 of the present invention referring to a flow chart shown in FIG. 1. Given that an audio search operation has already initiated, search to play a head point at a high speed is carried out in a forward direction or in a reverse direction while an audio information or a time information is being displayed in the audio search operation.

In Step S11, the microcomputer 14 judges whether or not the optical pickup 11 has reached the end of a last compressed audio data file (a piece of music) in a session currently being reproduced, and advances to Step S12 upon the judgment that the optical pickup 11 has reached the end.

In the Step S12, a time length of movement by force T of the optical pickup 11 is set in the microcomputer 14.

In Step S13, the microcomputer 14 instructs the servo circuit 13 to start up an operation of the forcible movement of the optical pickup 11 by the optical pickup driver 12.

In Step S14, the microcomputer 14 checks if counting up is terminated until the set up time length of movement by force T and thereby judges whether or not the forcible movement of the optical pickup 11 is completed, and then advances to Step S15 after the forcible movement of the optical pickup 11 is finished.

In the Step S15, the microcomputer 14 instructs the servo circuit 13 to move the optical pickup 11 to a head position of a first music in a next session by to the optical pickup driver 12, and restarts (continues) the audio search operation from Step S16.

According to the audio data search control apparatus of the present embodiment, the optical pickup 11 is forced to move along the radial direction of the multi-session disk 10 during the fixed time length of forcible-movement T after the search of the last compressed audio data file in the session is completed so that the head of the leading music in the next session can be accurately identified. The data output is interrupted during the forcible movement of the optical pickup in the step so that the data in the inter-session gap is not reproduced as output, and the jump over the inter-session gap is realized without the generation of any abnormal sound.

### Embodiment 2

Below is described an audio data search control apparatus according to an embodiment 2 of the present invention.

The forcible-movement time length T of the optical pickup is set to one value in the audio data search control apparatus according to the embodiment 1. Therefore, in a multi-session disk comprising at least three sessions and at least two inter-session gaps, it is necessary to set a length of time previously judged to be necessary for jumping over a maximum gap in the plurality of inter-session gaps as the forcible-movement time length T, in other words, it is necessary to include a margin. However, a dimension of the inter-session gap is reduced toward the outward direction in radius of the multi-session disk, and accordingly, the time length required for jumping over the gap should be shorter as going toward the out ward direction of radius. Then, the fixed forcible-movement time length T is unfavorably longer than the actual time length required for jumping over the gap. In other words, a time length more than necessary has to be consumed for jumping over the gap.

In the embodiment 2, the microcomputer 14 previously installs therein a forcible-movement time table in which a relationship between a position of the multi-session disk in the radial direction thereof and the forcible-movement time length that is the most suitable for the position is illustrated.

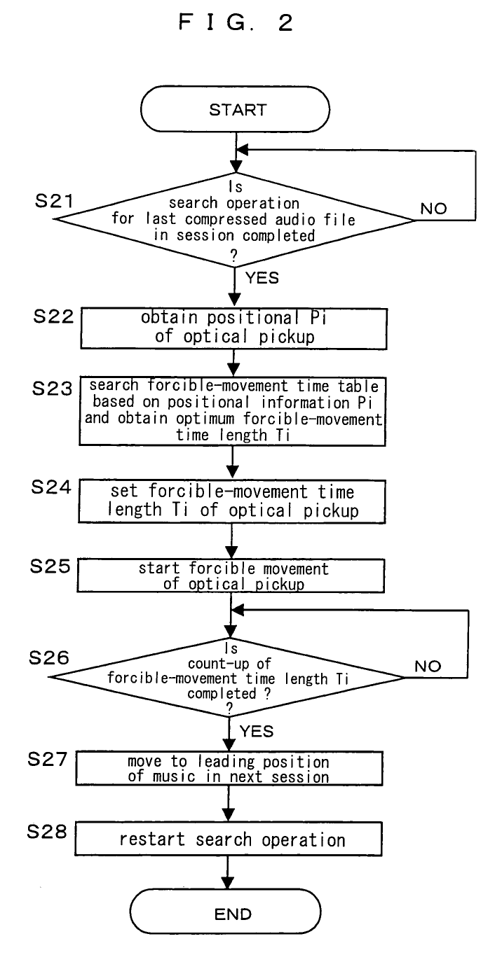

Below is described the audio data search control apparatus according to the embodiment 2 referring to a flow chart shown in FIG. 2.

In Step S21, the microcomputer 14 judges whether or not the optical pickup 11 has reached the end of the last compressed audio data file in the session being currently reproduced, and advances to Step S22 after the optical pickup 11 has reached the end.

In the Step S22, an information Pi indicating a current position of the optical pickup 11 is obtained and temporarily memorized in the microcomputer 14.

In Step S23, the forcible-movement time table previously installed in the microcomputer 14 is searched based on the memorized positional information Pi so as to obtain an optimum forcible-movement time length Ti. Further, in Step S24, the optimum forcible-movement time length Ti is set in the microcomputer 14.

In Step S25, the microcomputer 14 instructs the servo circuit 13 to start the forcible movement of the optical pickup 11.

In Step S26, the microcomputer 14 checks if the specified optimum time length of forcible-movement Ti has been finished to count up and thereby, judges whether the forcible movement of the optical pickup 11 is completed, and then advances to Step S27 after its completion.

In the Step S27, the microcomputer 14 moves the optical pickup 11 to the head of the first music in the next session, and restarts (continues) the audio search operation in and after Step S28.

According to the foregoing audio data search control apparatus, the forcible-movement time length Ti can be optimized based on the positional information Pi of the optical pickup 11. Therefore, jumping over the inter-session gap can be carried out for a minimum length of time required for the jump even if the inter-session gap is at any position in the radial direction of the multi-session disk 10. In brief, the head detection in the next session can be more speedily performed.

### Embodiment 3

Below is described an audio data search control apparatus according to an embodiment 3 of the present invention.

In the audio data search control apparatus according to the embodiment 1, the jump over the inter-session gap by the optical pickup is controlled based on the forcible-movement time length. However, a distance of the movement in the radial direction is more strictly important in jumping over the gap because the gap is a very dimension in the radial direction. There is supposedly a proportional relationship between radial-movement distance and the forcible-movement time length.

However, there is a variation in a proportional coefficient in the proportional relationship between the radial movement distance and the forcible-movement time length with respect to the multi-session disk 10 of the optical pickup 11 depending on a type of mechanism adopted in a drive motor of the optical pickup or a drive of the multi-session disk. Therefore, it becomes necessary to adjust(balance) the forcible-movement time length in accordance with the mechanism.

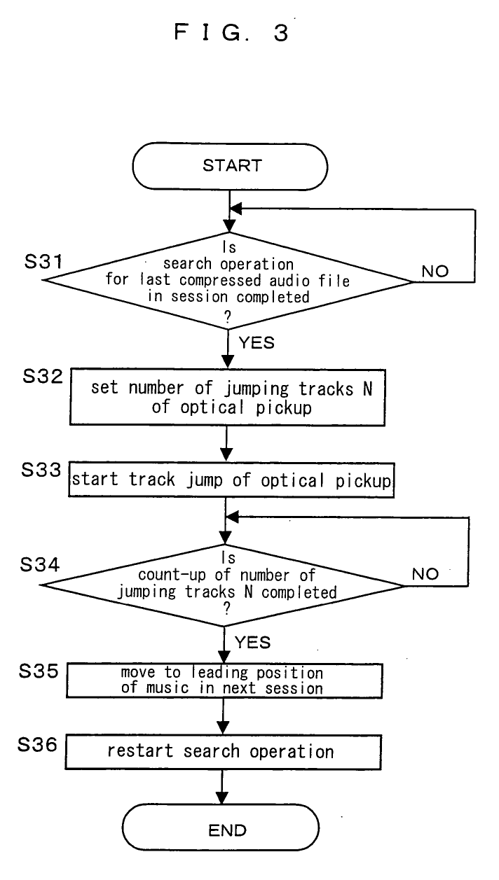

Below is described the audio data search control apparatus according to the embodiment 3 referring to a flow chart shown in FIG. 3.

In Step S31, the microcomputer 14 judges whether or not the optical pickup 11 has reached the end of the last compressed audio data file in the session currently being replayed, and advances to Step S32 after the optical pickup 11 has reached the end.

In the Step S32, number of jumping tracks N by the optical pickup 11 is set in the microcomputer 14.

In Step S33, the microcomputer 14 instructs the servo circuit 13 to start the track jump of the optical pickup 11.

In Step S34, the microcomputer 14 judges whether the track jump is completed through confirmation if the set number of the jumping tracks N has been counted up, and advances to Step S27 after it is completed.

In the Step S35, the microcomputer 14 moves the optical pickup 11 to the head of the first music in the next session, and restarts (continues) the audio search operation in and after Step S16.

According to the foregoing audio data search control apparatus, the jump over the inter-session gap by the optical pickup is controlled based on the number of the jumping tracks. The movement distance to radius direction is accurately reflected on the number of the jumping tracks, and the number of the jumping tracks is free of any influence from the type of mechanism adopted in the drive motor of the optical pickup or the drive of the optical disk drive. As a result, the adjustment due to the mechanism becomes unnecessary.

### Embodiment 4

Below is described an audio data search control apparatus according to an embodiment 4 of the present invention.

In the audio data search control apparatus according to the embodiment 3, the number of the jumping tracks N of the optical pickup is set to one value. Therefore, the number of the tracks previously judged to be necessary for jumping over the maximum gap in the plurality of inter-session gaps is set as the number of the jumping tracks N, which means that a margin is included. However, the dimension of the inter-session gap is reduced toward the outward direction in radius of the multi-session disk 10, and accordingly, the number of the jumping tracks required for jumping over the gap should be smaller toward the outward direction in radius because a circumferential length per the same center angle, that is the number of data, is increased toward the outward direction in radius. The fixed number of the jumping tracks N in the embodiment 3 is larger than the number of the tracks required for jumping over the gap. In other words, a length of time more than necessary has to be spent on jumping over the gap.

In the embodiment 4, the microcomputer 14 has a built-in jumping-track number table in which a relationship between the position of the multi-session disk in the radial direction thereof and the number of the jumping tracks that is the most suitable for the position is illustrated.

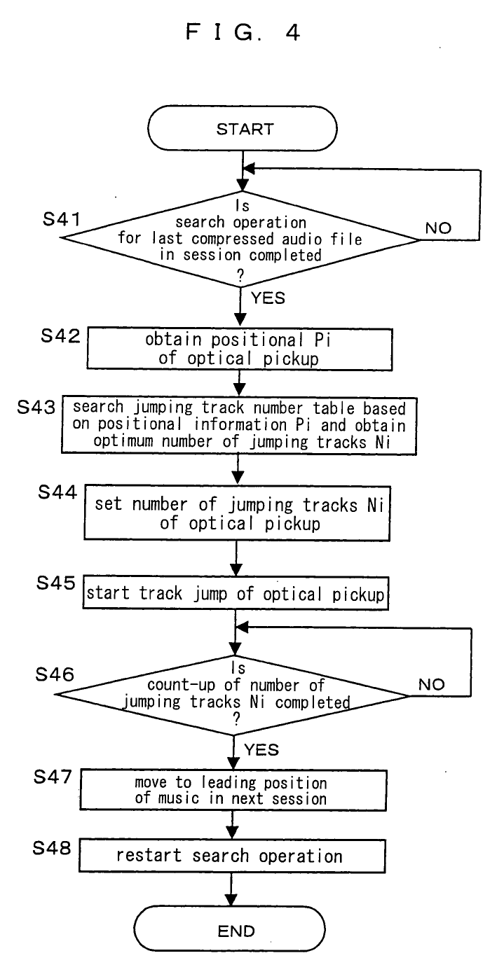

Below is described the audio data search control apparatus according to the embodiment 4 referring to a flow chart shown in FIG. 4.

In Step S41, the microcomputer 14 judges whether or not the optical pickup 11 has reached the end of the last compressed audio data file in the session being currently replayed, and advances to Step S42 after it has reached the end.

In the Step S42, the information Pi on the current position of the optical pickup 11 is obtained and temporarily memorized in the microcomputer 14.

In Step S43, search is carried out with the jumping-track number table built in previously inside the microcomputer 14 based on the memorized positional information Pi so as to obtain an optimum number of jumping tracks Ni. Further, in Step S44, the optimum jumping-track number Ni is set in the microcomputer 14.

In Step S45, the microcomputer 14 instructs the servo circuit 13 to start the track-jump process of the optical pickup 11.

In Step S46, the microcomputer 14 judges whether the track-jump process is completed based on confirmation if counting up has been finished until the set optimum jumping-track number Ni, and advances to Step S47 after the completion of the track-jump process.

In the Step S47, the microcomputer 14 moves the optical pickup 11 to the head of the first music in the next session, and restarts (continues) the audio search operation following to Step S48.

According to the foregoing audio data search control apparatus, the jumping-track number Ni can be optimized based on the positional information Pi of the optical pickup 11. Therefore, the jump is carried out at a minimum number of jumping tracks required for jumping over the inter-session gap even though the inter-session gap is at any position in the radial direction of the multi-session disk 10. In brief, the cue in the next session can be more speedily identified. In the same manner as in the embodiment 3, it is unnecessary to adjust the number of the jumping tracks in accordance with the mechanism, which leads to the reduction of manufacturing steps and cost.

### Embodiment 5

Below is described an audio data search control apparatus according to an embodiment 5 of the present invention.

In Step S51, the microcomputer 14 judges whether or not the optical pickup 11 has reached the end of the last compressed audio data file in the session currently being replayed, and advances to Step S52 after it has reached to the end.

In the Step S52, the information Pi is obtained which indicates the current position of the optical pickup 11 and temporarily memorized in the microcomputer 14.

In Step S53, the jumping-track number table previously installed in the microcomputer 14 is searched based on the memorized positional information Pi so as to obtain the optimum number of jumping tracks Ni. Further, in Step S54, the optimum jumping-track number Ni is set in the microcomputer 14.

In Step S55, the microcomputer 14 instructs the servo circuit 13 to start the track-jump process of the optical pickup 11.

In Step S56, the microcomputer 14 judges whether the track-jump process is completed based on confirmation if counting up is finished until the set optimum jumping-track number Ni, and advances to Step S57 when the track-jump process is not completed, while advancing to Step S65 when completed.

In the Step S57, it is monitored if a track-jump error is generated. The microcomputer 14 goes back to the Step S56 when the error is not detected, while advancing to Step S58 when the error is detected. In the Step S58, the microcomputer 14 gives increment (+1) to an error retry counter and advances to Step S59, in which it is judged whether or not the retry counter exceeds a set value (max). When it is below the value, the microcomputer 14 goes back to the Step S56, while advancing to Step S60 when it exceeds the one (max) before the completion of the track-jump process.

In the case of installing a multi-session disk comprising a mirror surface in which there is no track in the inter-session gap, the jump over the gap results in a failure because of the absence of the track when based on the number of the jumping tracks._As a result, the step shifts as S55→S56→S57→S58→S59→S60. In case that the installed multi-session disk 10 does not have the mirror surface in the inter-session gap, there is a high possibility that the microcomputer 14 does not proceed to the Step S60 and shift from the Step S56 to the Step S65 instead. When the multi-session disk has a stain or a scratch on a surface thereof even though the there is no mirror surface therein, the process flow may shift to the Step S60.

In the Step S60, the information Pi is obtained which indicates the current position of the optical pickup 11 and temporarily memorized in the microcomputer 14.

In Step S61, the forcible-movement time table is searched which is previously installed in the microcomputer 14 based on the memorized positional information Pi so as to obtain the optimum forcible-movement time length Ti. Further, in Step S62, the optimum time length of forcible-movement Ti is set in the microcomputer 14.

In Step S63, the microcomputer 14 instructs the servo circuit 13 to start the forcible movement of the optical pickup 11.

In Step S64, the microcomputer 14 judges if the forcible movement of the optical pickup 11 is completed based on confirmation whether counting up is finished until the set optimum time length of forcible-movement Ti, and advances to Step S65 when it is completed. The microcomputer 14 also shifts to the Step S65 when the track jump is successful in the Step S55 and the judgment of the step S56 is positive.

In the Step S65, the microcomputer 14 moves the optical pickup 11 to the head of the first music in the next session, and restarts (continues) the audio search operation in and after Step S66.

According to the foregoing audio data search control apparatus, in the case of installing the multi-session disk having the mirror surface in the inter-session gap, the jump over the gap based on forcible-movement time length is adopted instead of the one based on the number of the jumping tracks because the jump over failed in the latter so that the jump over the inter-session gap can be realized without generating any abnormal sound in the multi-session disk comprising the mirror surface in the same manner. If the installed multi-session disk does not include the mirror surface, the gap jump based on the number of the jumping tracks on which the movement distance to radial direction is accurately reflected can be successfully carried out. Therefore, the adjustment in accordance with the mechanism becomes unnecessary, which effectively reduces the manufacturing cost.

### Embodiment 6

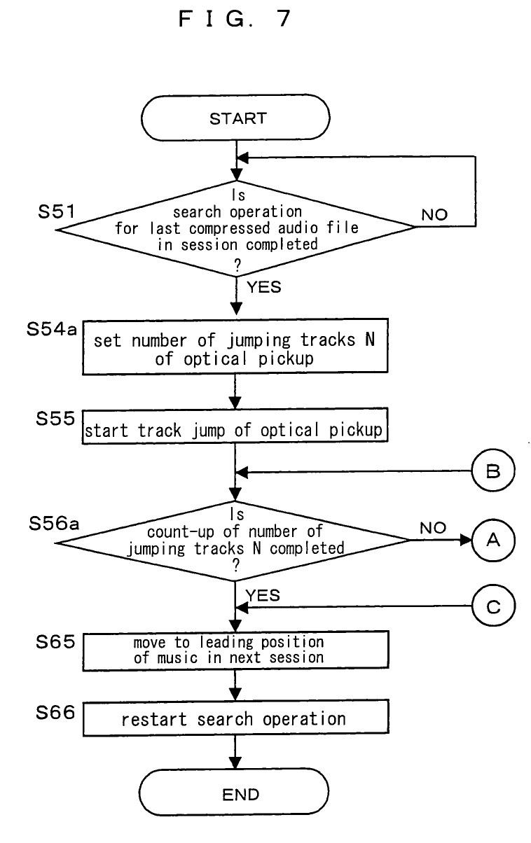

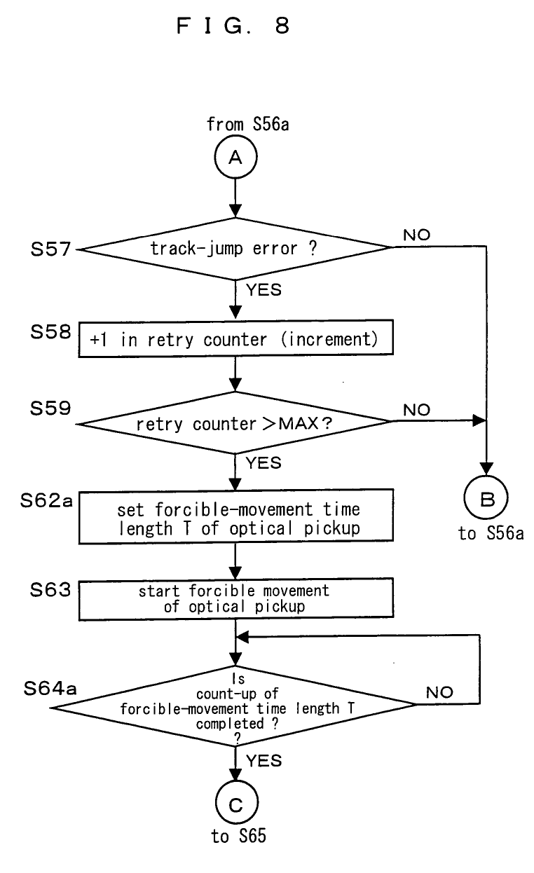

FIGS. 7 and 8 respectively show flow charts of an audio data search control apparatus according to an embodiment 6 of the present invention. The embodiment 6 consists of a two routes method for attempting the gap jump based on the number of the jumping tracks which does not need the optimization according to the embodiment 3, and in case of failing to do so, shifting to the gap jump based on the forcible-movement time length which does not need the optimization according to the embodiment 1.

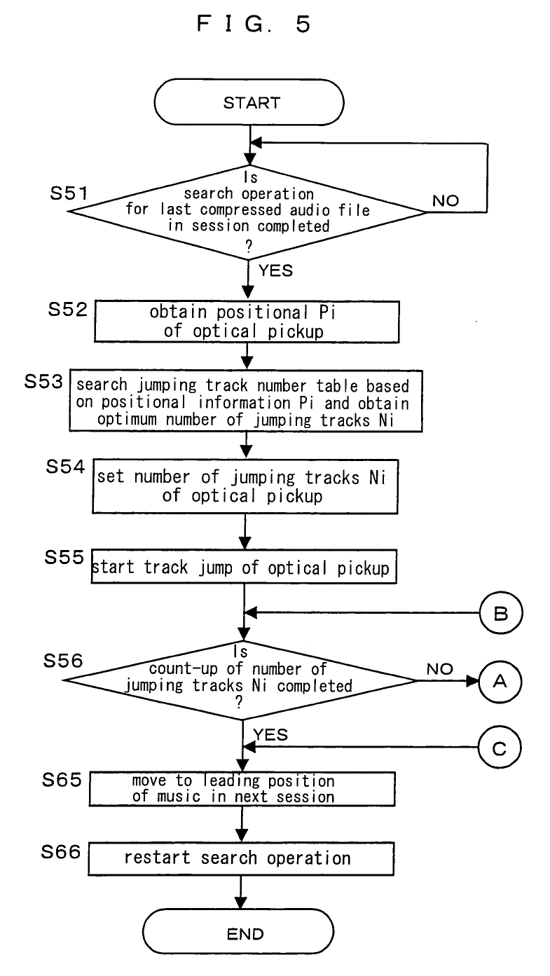

In FIG. 7 based on FIG. 5, the Step S52 for obtaining the positional information Pi of the optical pickup and the Step S53 for obtaining the corresponding optimum number of the jumping tracks Ni shown in FIG. 5 are omitted, and N is used instead of Ni in Steps S54a and S56a.

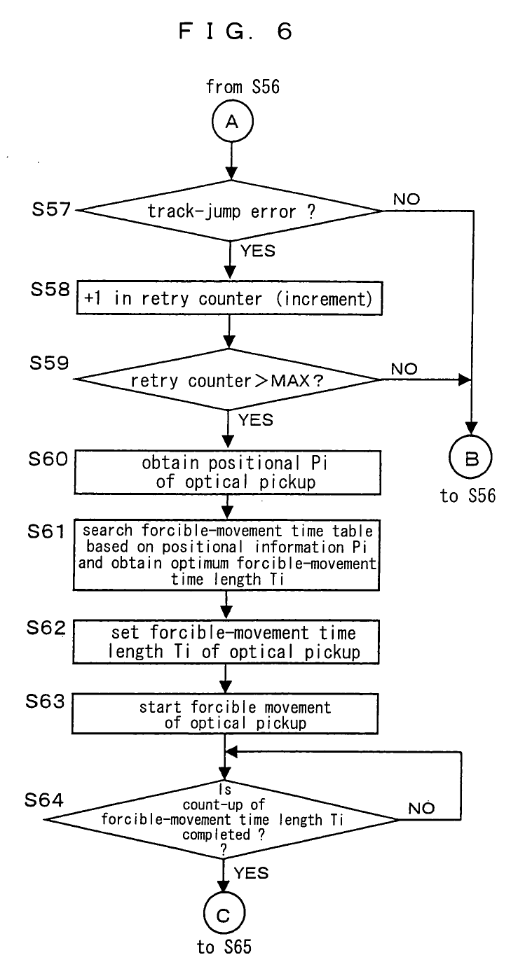

In FIG. 8 based on FIG. 6, the Step S60 for obtaining the positional information Pi of the optical pickup and the Step S61 for obtaining the corresponding optimum forcible-movement time length Ti shown in FIG. 6 are omitted, and T is used instead of Ti in Steps S62a and S64a.

### Embodiment 7

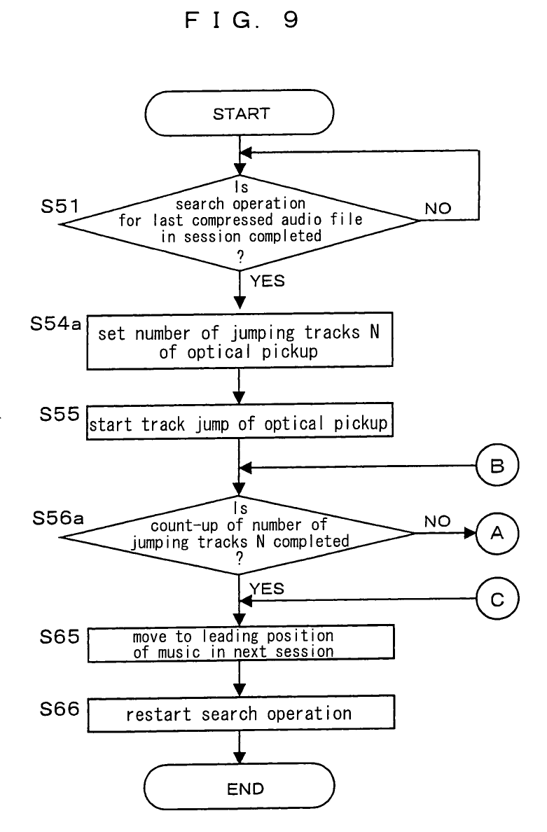

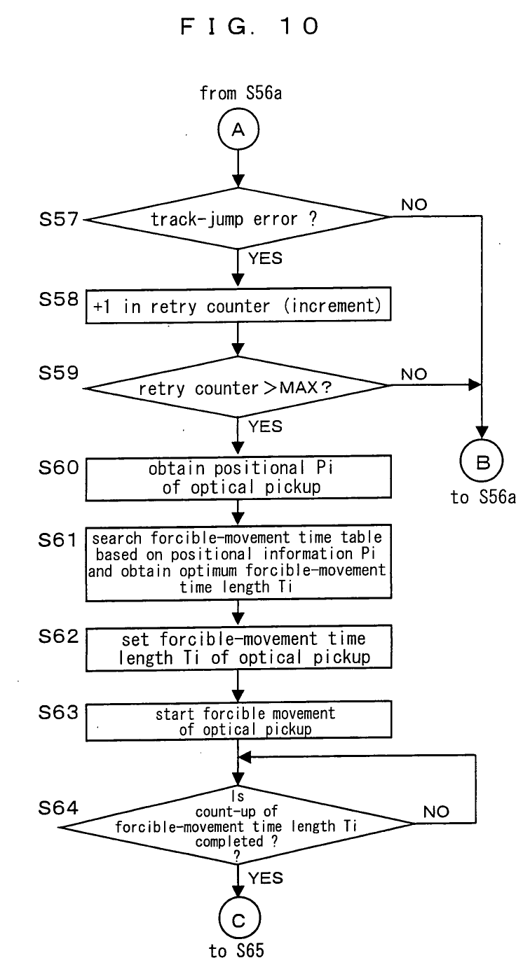

FIGS. 9 and 10 respectively show flow charts of an audio data search control apparatus according to an embodiment 7 of the present invention. The embodiment 7 takes a method consisting of two routes for attempting the gap jump based on the number of the jumping tracks which does not need the optimization according to the embodiment 3, and in case of failing to do so, shifting to the gap jump based on the optimized forcible-movement time length which does not need any optimization in the embodiment 2.

In FIG. 9 based on FIG. 5, the Steps S52 and S53 shown in FIG. 5 are omitted, and Ni is replaced with N in Steps S54a and S56a.

FIG. 10 is identical to FIG. 6.

### Embodiment 8

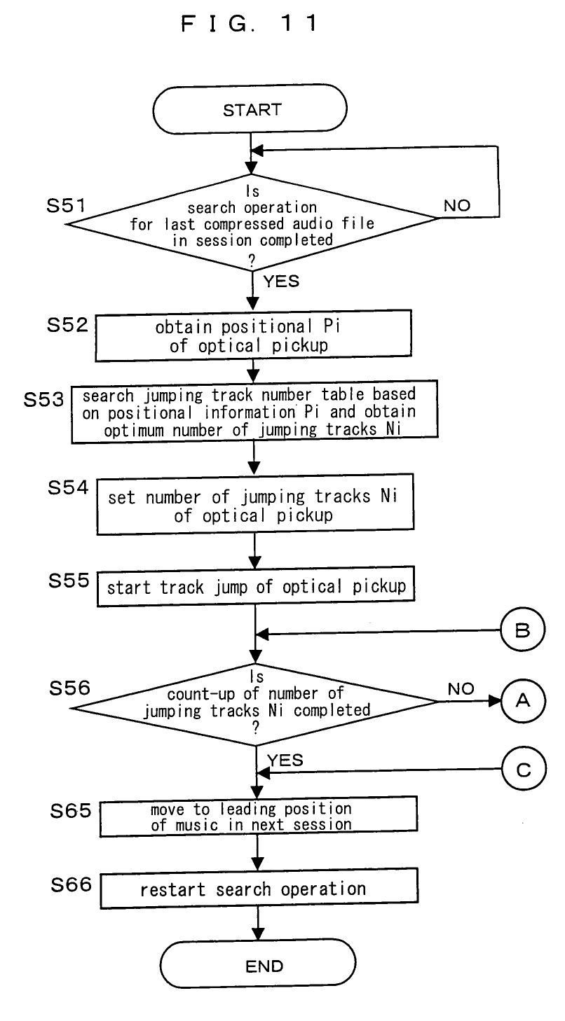

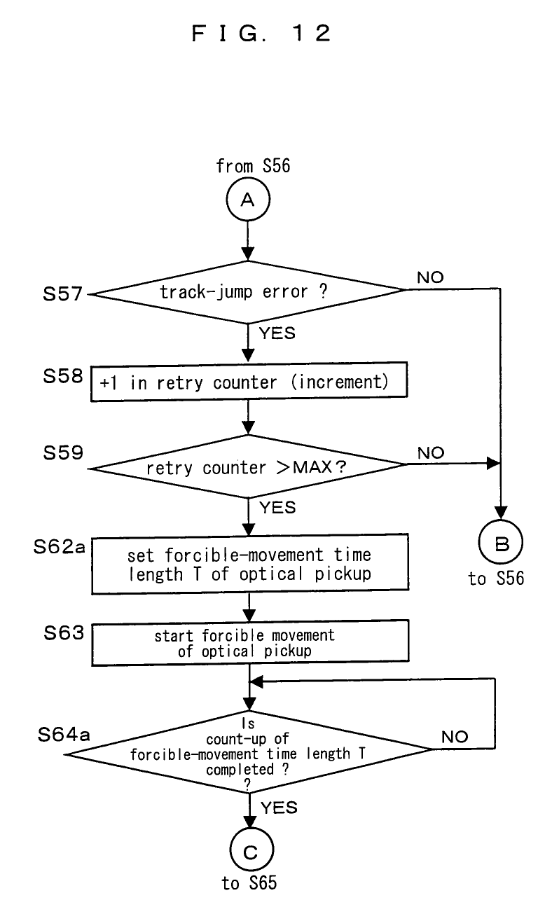

FIGS. 11 and 12 respectively show flow charts of an audio data search control apparatus according to an embodiment 8 of the present invention. The embodiment 8 employs a two routes method for attempting the gap jump based on the optimized number of the jumping tracks adopted in the embodiment 4, and when it failed to do so, shifting the gap jump based on the forcible-movement time length adopted in the optimization according to the embodiment 1.

FIG. 11 is identical to FIG. 5.

In FIG. 12 based on FIG. 6, the Steps S60 and S61 shown in FIG. 6 are omitted, and Ti is replaced with T in Steps S62a and S64a.

### INDUSTRIAL APPLICABILITY

The present invention can be applied to an audio data search control apparatus for identifying a head of an audio data file in a multi-session disk comprising a plurality of sessions as in a CD (compact disk) on which audio data files according to different formats are intermingled such as MP3 and CD-DA.

What is claimed is:

1. An audio data search control apparatus comprising:
a pickup capable of moving on a multi-session disk in a radial direction thereof; and
a microcomputer for controlling the movement of the pickup, wherein the microcomputer executes:
a first step for judging whether or not a search operation for a last audio data file in an optional session is completed during the search operation in the session;
a second step for forcing to move the pickup during a required forcible-movement time length along the radial direction of the disk upon the judgment in the first step that the search operation is completed; and
a third step for restarting the search operation in a next session according to a different format after the forcible movement is completed.

2. The audio data search control apparatus according to claim 1, wherein
an optimum forcible-movement time length corresponding to a positional information of the pickup on the disk is obtained, and the pickup is forcibly moved along the radial direction of the disk during the optimum forcible-movement time length in the second step upon the judgment in the first step that the search operation is completed.

3. An audio data search control apparatus comprising:
a pickup capable of moving on a multi-session disk in a radial direction thereof; and
a microcomputer for controlling the movement of the pickup, wherein
the microcomputer executes:
a first step for judging whether or not a search operation for a last audio data file in an optional session during the search operation in the session;
a second step for jumping the pickup over a required number of jumping tracks along the radial direction of the disk upon the judgment in the first step that the search operation is completed; and
a third step for restarting the search operation in a next session according to a different format when the track jump is completed in the second step.

4. The audio data search control apparatus according to claim 3, wherein
an optimum number of jumping tracks corresponding to a positional information of the pickup on the disk is obtained, and the pickup is jumped over the optimum number of jumping tracks along the radial direction of the disk in the second step upon the judgment in the first step that the search operation is completed.

5. The audio data search control apparatus according to claim 3, wherein
the pickup is jumped over a required number of jumping tracks along the radial direction of the disk, it is judged whether or not the track jump is successful, and the pick up is forcibly moved during a required forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

6. The audio data search control apparatus according to claim 3, wherein
an optimum number of jumping tracks corresponding to a positional information of the pickup on the disk is obtained, the pickup is jumped over the optimum number of jumping tracks along the radial direction of the disk, it is judged whether or not the track jump is successful, and an optimum forcible-movement time length corresponding to a positional information of the pickup on the disk is obtained and the pickup is forcibly moved during the optimum forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

7. The audio data search control apparatus according to claim 3, wherein
the pickup is jumped over a required number of jumping tracks along the radial direction of the disk, it is judged whether or not the track jump is successful, and an optimum forcible-movement time length corresponding to a positional information of the pickup on the disk is obtained and the pickup is forcibly moved during the optimum forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

8. The audio data search control apparatus according to claim 3, wherein
an optimum number of jumping tracks corresponding to a positional information of the pickup on the disk is obtained, the pickup is jumped over the optimum number of jumping tracks along the radial direction of the disk, it is judged whether or not the track jump is successful, and the optical pickup is forcibly moved during a required forcible-movement time length along the radial direction of the disk when the track jump results in a failure in the second step upon the judgment in the first step that the search operation is completed,
the search operation is restarted in a next session according to a different format in the third step when the track jump is successful or the forcible movement is completed in the second step.

9. The audio data search control apparatus according to claim 5, wherein
a retry process of the track jump is executed in the second step when the track jump results in a failure.

10. An audio data search control method for identifying a cue of an audio data recorded on a multi-session disk using a pickup capable of moving on the disk in a radial direction thereof and a microcomputer for controlling the movement of the pickup, wherein
the microcomputer executes:
a first step for judging whether or not a search operation for a last audio data file in an optional session is completed during the search operation in the session;
a second step for forcibly moving the pickup during a required forcible-movement time length along the radial direction of the disk upon the judgment in the first step that the search operation is completed; and
a third step for restarting the search operation in a next session according to a different format after the forcible movement is completed.

11. The audio data search control method according to claim 10, wherein
an optimum forcible-movement time length corresponding to a positional information of the pickup on the disk is obtained, and the pickup is forcibly moved along the radial direction of the disk during the optimum forcible-movement time length in the second step upon the judgment in the first step that the search operation is completed.

12. An audio data search control method for identifying a cue of an audio data recorded on a multi-session disk using a pickup capable of moving on the disk in a radial direction thereof and a microcomputer for controlling the movement of the pickup, wherein
the microcomputer executes:
a first step for judging whether or not a search operation for a last audio data file in an optional session during the search operation in the session;
a second step for jumping the pickup over a required number of jumping tracks along the radial direction of the disk upon the judgment in the first step that the search operation is completed; and
a third step for restarting the search operation in a next session according to a different format when the track jump is completed in the second step.

13. The audio data search control method according to claim 12, wherein
an optimum number of jumping tracks corresponding to a positional information of the pickup on the disk is obtained, and the pickup is jumped over the optimum number of jumping tracks along the radial direction of the disk in the second step upon the judgment in the first step that the search operation is completed.

14. The audio data search control method according to claim 12, wherein
the pickup is jumped over a required number of jumping tracks along the radial direction of the disk, it is judged whether or not the track jump is successful, and the pick up is forcibly moved during a required forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

15. The audio data search control method according to claim 12, wherein
an optimum number of jumping tracks corresponding to a positional information of the pickup on the disk is obtained, the pickup is jumped over the optimum number of jumping tracks along the radial direction of the disk, it is judged whether or not the track jump is successful, and an optimum forcible-movement time length corresponding to the positional information of the pickup on the disk is obtained and the pickup is forcibly moved during the optimum forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

16. The audio data search control method according to claim 12, wherein
the pickup is jumped over a required number of jumping tracks along the radial direction of the disk, it is judged whether or not the track jump is successful, and an optimum forcible-movement time length corresponding to a positional information of the pickup on the disk is obtained and the pickup is forcibly moved during the optimum forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

17. The audio data search control method according to claim 12, wherein
an optimum number of jumping tracks corresponding to a positional information of the pickup on the disk is obtained, the pickup is jumped over the optimum number of jumping tracks along the radial direction of the disk, it is judged whether or not the track jump is successful, and the optical pickup is forcibly moved during a required forcible-movement time length along the radial direction of the disk when the track jump results in a failure in the second step upon the judgment in the first step that the search operation is completed, and
the search operation is restarted in a next session according to a different format in the third step when the track jump is successful or the forcible movement is completed in the second step.

18. The audio data search control apparatus according to claim 12, wherein
a retry process of the track jump is executed when the track jump results in a failure in the second step.

19. The recording medium on which a program for the computer of the audio data search control apparatus as recited in any of claims 1 through 9 to execute the respective steps is recorded.

20. The program for the computer of the audio data search control apparatus as recited in any of claims 1 through 9 to execute the respective steps.
